(19) United States
(12) Patent Application Publication
(10) Pub. No.: US 2026/0077795 A1
(43) Pub. Date: Mar. 19, 2026

(54) Cart For Moving Panels

(71) Applicant: Signature Wall Solutions, Inc., Midland, MI (US)

(72) Inventors: Wiljo E. ASIALA, JR., Midland, MI (US); Zachary E. Cesa, Midland, MI (US); Kenneth Staten, Clare, MI (US); Leah Lindauer, Midland, MI (US); Jeffrey Adams, Mount Pleasant, MI (US)

(21) Appl. No.: 19/305,137

(22) Filed: Aug. 20, 2025

Related U.S. Application Data
(60) Provisional application No. 63/695,570, filed on Sep. 17, 2024.

(51) Int. Cl. B62B 3/16; B62B 3/02; B62B 3/10

(52) U.S. Cl. CPC B62B 3/16; B62B 3/02; B62B 3/108

(57) ABSTRACT

A cart includes a tray having a base having a first edge having a first wall extending therefrom and a second edge opposite the first edge having second wall extending therefrom. A plurality of wheels is coupled to the tray. A first support assembly includes a first cross member rotatably coupled between the first wall and the second wall and adjacent to a second edge. The first support assembly includes a first panel support coupled to the first cross member and a first stack support coupled to the first cross member. A second support assembly includes a second cross member rotatably coupled between the first wall and the second wall and adjacent to a fourth edge. The second support assembly includes a second panel support coupled to the second cross member and a second stack support coupled to the second cross member.

### CROSS-REFERENCE TO RELATED APPLICATIONS

This application claims the benefit of U.S. Provisional Application No. 63/695,570, filed on Sep. 17, 2024. The entire disclosure of the above application is incorporated herein by reference.

### FIELD

The present disclosure relates generally to a cart, and, more particularly, to a cart for moving panels such as panels and components of a wall system.

### BACKGROUND

Temporary and permanent wall systems have been in use for many years. Wall systems that are reusable are used in many industries. Temporary wall systems may be used to separate an area under construction from an area that is still used by customers. The wall systems separate dirt and noise associated with a construction area with the portions of the structure that are still in use. Temporary wall systems can also be used to reduce an amount of floor area heated and cooled in a larger structure, while allowing expansion when needed. The wall systems have a panel with edge joiners that interlock to seal the area behind and hold the panels together. The wall panels are typically secured to the floor and to the ceiling in a track.

Wall panels are relatively large and extend from floor to ceiling. While many types of panels are formed from light materials, the size of the panels creates an impediment to carrying. Efficiently moving the panels to and from the job site is important.

### SUMMARY

The ability to reliably assemble and disassemble a wall system and have the wall system look aesthetically pleasing is important. Reusing wall components and using less materials is environmentally suitable and cost-effective. Conveniently moving the wall panels to and from the job site is also important.

In one aspect of the disclosure, a cart is used for moving the wall panels is set forth. The cart includes a tray having a base having a first edge having a first wall extending therefrom and a second edge opposite the first edge having second wall extending therefrom. A plurality of wheels is coupled to the tray. A first support assembly includes a first cross member rotatably coupled between the first wall and the second wall and adjacent to a second edge. The first support assembly includes a first panel support coupled to the first cross member and a first stack support coupled to the first cross member. A second support assembly includes a second cross member rotatably coupled between the first wall and the second wall and adjacent to a fourth edge. The second support assembly includes a second panel support coupled to the second cross member and a second stack support coupled to the second cross member.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a perspective view of a wall panel assembly that may be moved in sections using the cart of the present disclosure.

FIG. 2A is a perspective view of the cart in a panel moving position.

FIG. 2B is a perspective view of the cart in a cart support position.

FIG. 2C is a perspective view of two carts in a cart support position with an upper cart supported by a lower cart.

FIG. 2D is a front view of the cart of FIGS. 2A and 2B in the panel movement position.

FIG. 2E is a top view of the cart.

FIG. 2F is an end view of the cart having panels relative thereto.

FIG. 3A is a side view of the cross member and stack support of FIGS. 2A-2F.

FIG. 3B is a perspective view of the cross member and stack support.

FIG. 4A is a side view of the support cross member.

FIG. 4B is a perspective view of the support cross member.

FIG. 5A is a perspective view of a cross member.

FIG. 5B is a bottom view of the cross member.

FIG. 6 is a perspective view of a panel stop.

FIG. 7 is a perspective view of a second stop.

FIG. 8A is a perspective view of the panel support 142.

FIG. 8B is a side view of the panel support 142.

FIG. 8C is another side view of the panel support member.

FIG. 8D is a perspective view of a receiver.

FIG. 8E is a perspective view of the top member and the openings at either end.

FIG. 8F is an enlarged perspective view of the top member, receiver and panel support coupling.

FIG. 9 is an elevation view of a pin ring suitable for use at the panel supports.

FIG. 10A is a perspective view of a corner bracket used for within the tray.

FIG. 10B is a top view of the corner bracket of FIG. 10A.

### DETAILED DESCRIPTION

Example embodiments will now be described more fully with reference to the accompanying drawings.

In the present disclosure, separate joiners have been eliminated by using the core as a joiner. As is described herein, the core is a foam material strong enough to reduce damage during the assembly and disassembly process while being lightweight.

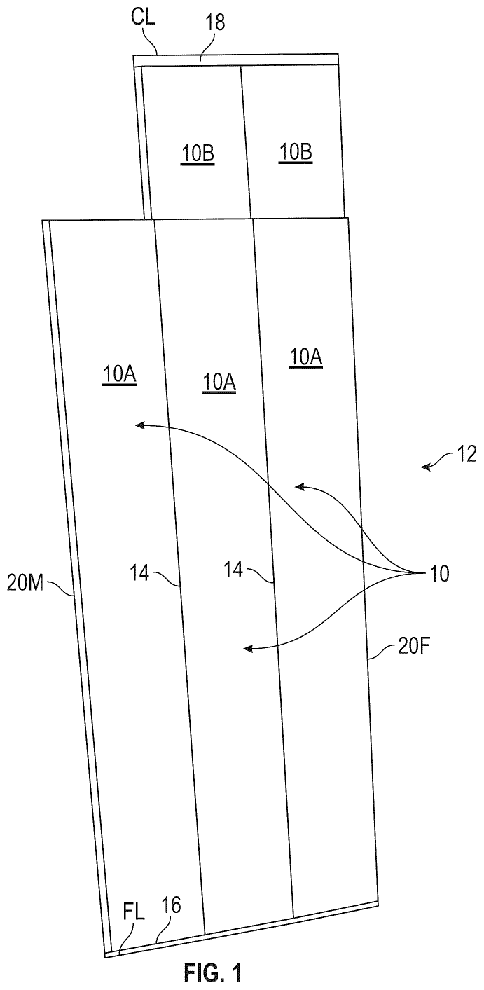

Referring now to FIG. 1, a front or finished-side view of a plurality of extendable wall panel assemblies 10 joined together to form a wall system 12 are illustrated. The cart described in greater detail below may be used for extendable panels and fixed panels. The “front” side provides a more finished look and is intended to be customer facing. However, the word front is meant as a reference to the more aesthetically pleasing side. Certainly, the back side may be customer-facing as well. The panel assemblies 10 each comprise and lower or front fixed panel 10A and an upper or back extendable panel 10B. The panel assemblies 10 are joined together and illustrated in an extended position. The leftmost upper panel (relative to the front side) is removed to illustrate the rear configuration. In use, the panel assemblies 10 are shipped assembled so that in a lowered position with the extendable panel 10B in a downward position. The extendable panel 10B may then be easily extended. The wall panel assemblies 10, when assembled, rest on the floor at the floor line FL or within a channel or lower track 16 on the floor line FL. An upper edge of the wall panel assemblies 10 are fastened to the building structure or ceiling denoted by ceiling line CL directly or using a track 18.

The words fixed and extendable are used to denote the in-use positions while being installed. The wall panel assemblies 10 are transportable and intended to be used as temporary walls that are fixed during use. The fixed panels 10A are placed into position and the extendable panels 10B are moved vertically into position where they are fixed until removal.

The adjacent panel assemblies 10 form joints as will be further described below. Seams 14 are formed at the joints when assembled. The seams 14 are hardly noticeable when the panels 10 are assembled when the same finishing materials are used. In this example, three fixed panel 10As are joined together and therefore two seams 14 are shown. Two extendable panels 10Bs are joined together at a joint that form the seam 14. In many examples, the panels are used for blocking a construction area. The joints may be formed by a male joiner 20M that is inserted or interlocked to a female joiner 20F.

The panel assemblies 10 may be various sizes. In a commercial example, the lengths may be standardized such as 4 feet, 8 feet, and 16 feet, although another length can be used. The seams 14 may also vary in length. The seams 14 run the height of the wall panel assembly 10. For example, 2 foot to 16 foot high panels may be used. Facilitating the joining and separation of these components to increase reusability in the shape of the design is desirable.

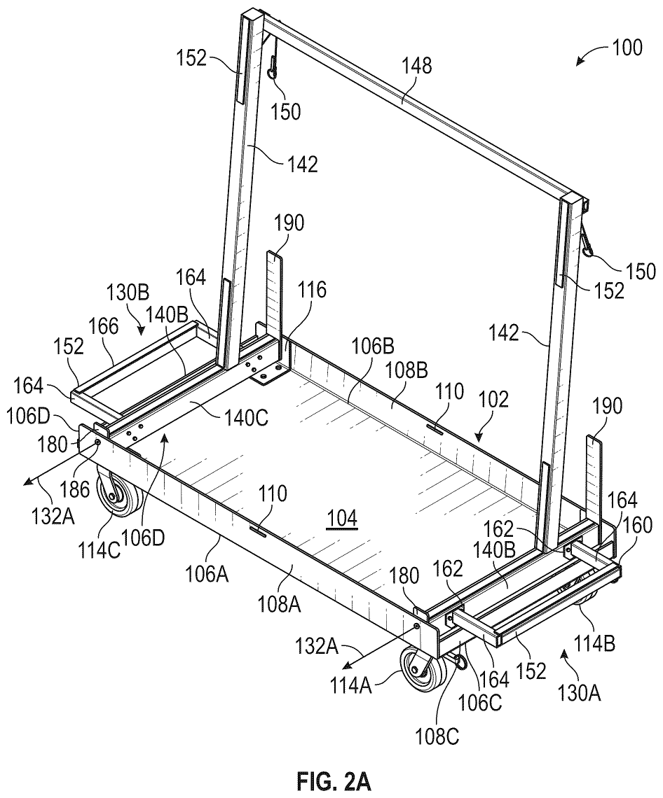

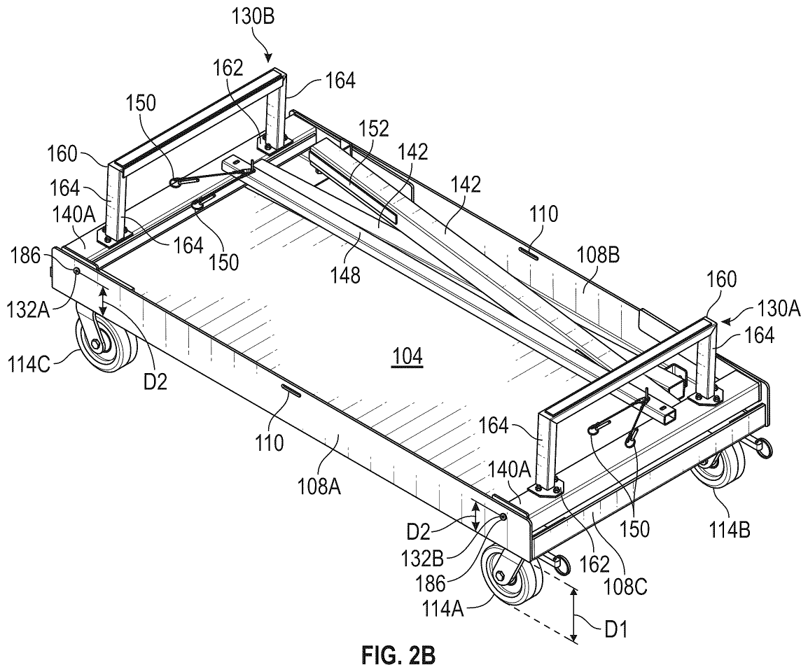

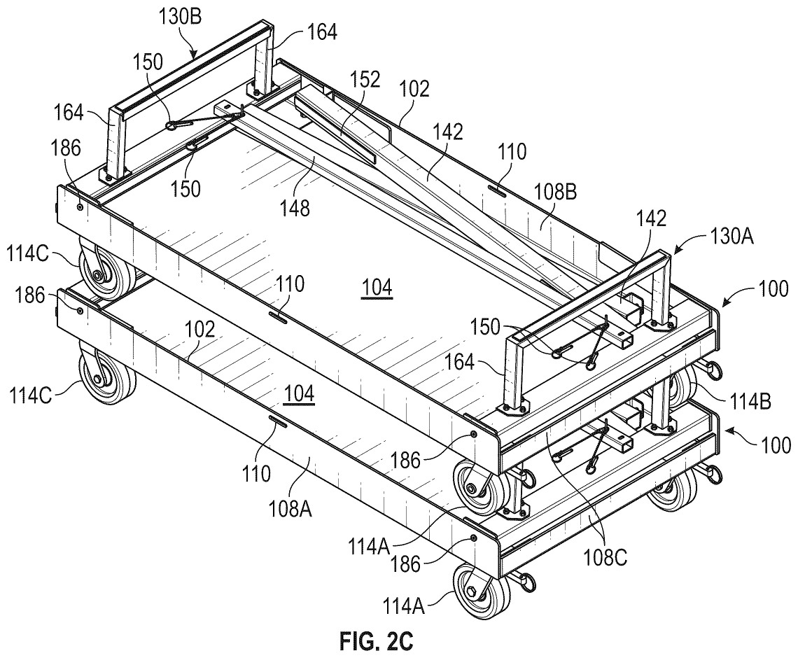

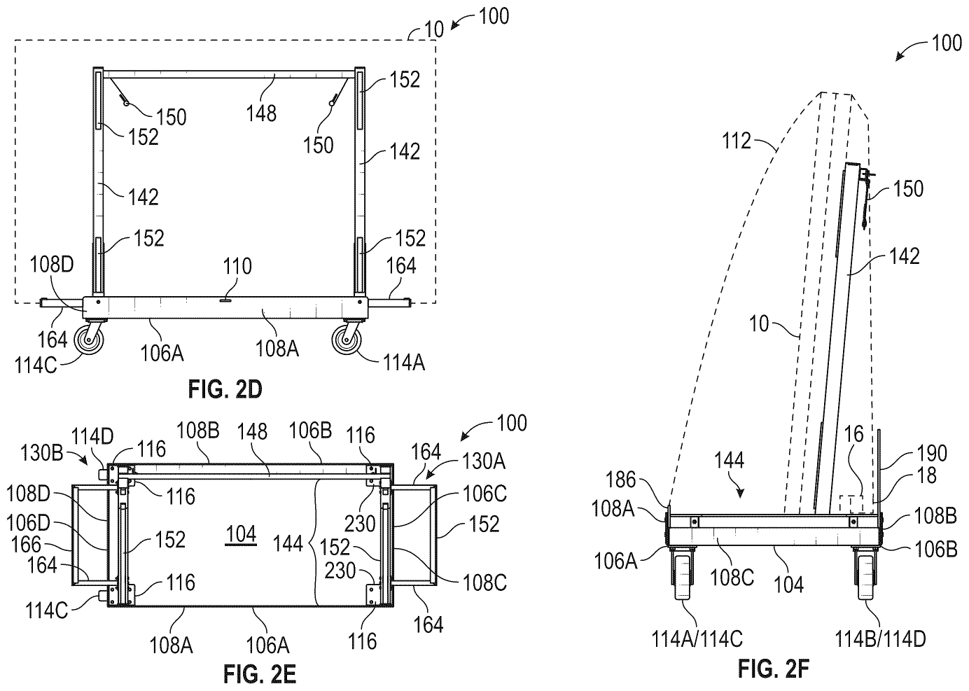

Referring now to FIGS. 2A-2F, a cart 100 that is suitable for moving a plurality of panel assemblies 10 is set forth. The cart 100 is suitable for carrying extendable panels, such as that illustrated in FIG. 1, non-extendable panels, portions of the panels or components such as the tracks and fasteners. An example of panels 10 and tracks 16, 18 is illustrated in FIGS. 2D and 2F below.

A cart 100 has a tray 102 having a base 104. The base 104 is rectangular in the present example. The base 104 has edges 106A-106D. The edges 106A and 106B are on the elongated edges of the base 104. The edges 106C and 106D are on the shorter lateral edges of the base.

Walls 108A-108D extend vertically from the edges 106A-106D, respectively. In the present example, the walls 108A and 108B extend from edges 106A, 106B, respectively. In the present example, the walls 108A, 108B extend the same distance from the base 104 in a vertical direction.

The walls 108C and 108D extend from the edges 106C and 106D. In this example, the walls 108C and 108D extend the same distance vertically from the base 104 which is less than the vertical distance of the walls 108A, 108B. By providing the walls 108A-108D around the base 104, tools, fasteners, and other components may be secured within the tray 102 during movement of the panels 10.

The walls 108A, 108B may have slots 110 extending therethrough. The slots 110 may be used for securing straps thereto to secure the panels 10 during movement with the cart 100. Clips or fasteners (not shown) may secure within the slots 110.

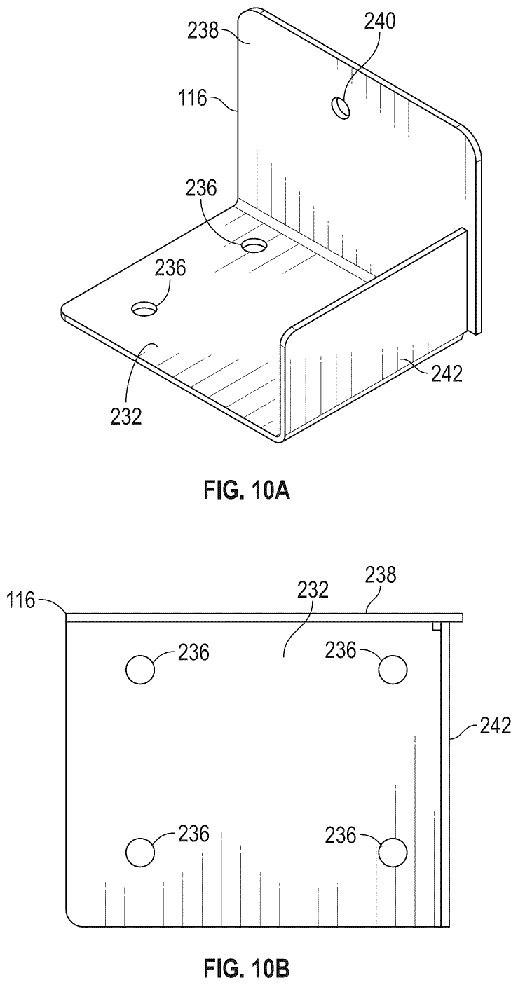

The cart 100 has a plurality of wheel assemblies 114A-114D coupled to the underside of the base 104. The wheel assemblies 114A-114D may have two wheel assemblies, such as 114A and 114B, that swivel while wheels 114C and 114D are fixed in direction. The wheel assemblies 114A-114D may couple directly to the base 104. However, the wheel assemblies 114 also coupled to corner brackets 116. Two corner brackets 116 may be formed as mirror images. Details of the corner brackets 116 are set forth in FIGS. 10A and 10B. The wheel assemblies 114A-114D extend a distance D₁ from the bottom of the base 104.

The cart 100 has a first support assembly 130A and a second support assembly 130B. The support assemblies 130A, 130B are shown in a first position in FIGS. 2B and 2C whereby the support assemblies130A and130B are used to support multiple carts 100. In FIG. 2C, two carts are shown with the upper carts supported by the support assemblies 130A, 130B of the lower cart in the upright position. FIG. 2A shows the support assemblies 130A, 130B in a second position or open position that is used for moving panels therewith. The support assemblies 130A, 130B nest within the tray 102 when folded as illustrated in FIG. 2B. In FIG. 2B, a support assembly 130A rotates around an axis 132A while the support assembly 130B rotates around the axis 132B. Each axis 132A, 132B extend laterally across the cart 100. Axis 132A is positioned a distance D₂ above the base 104. Axis 132B is positioned the same distance D2 above the base 104.

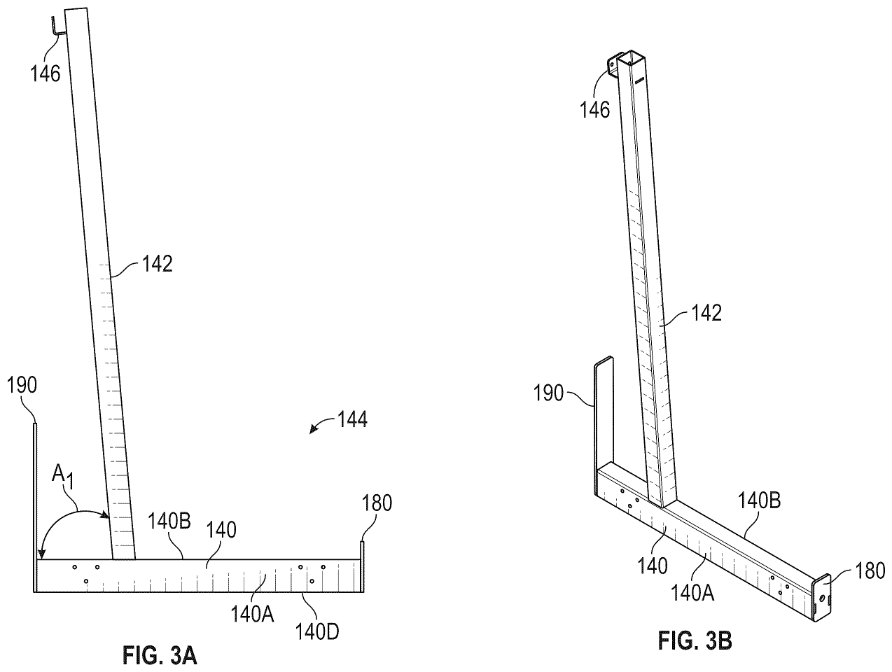

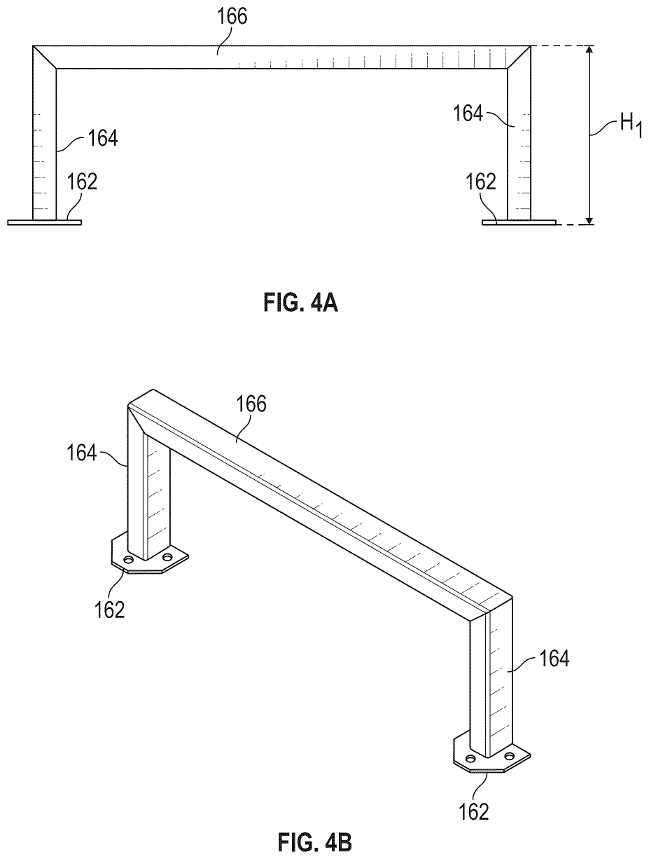

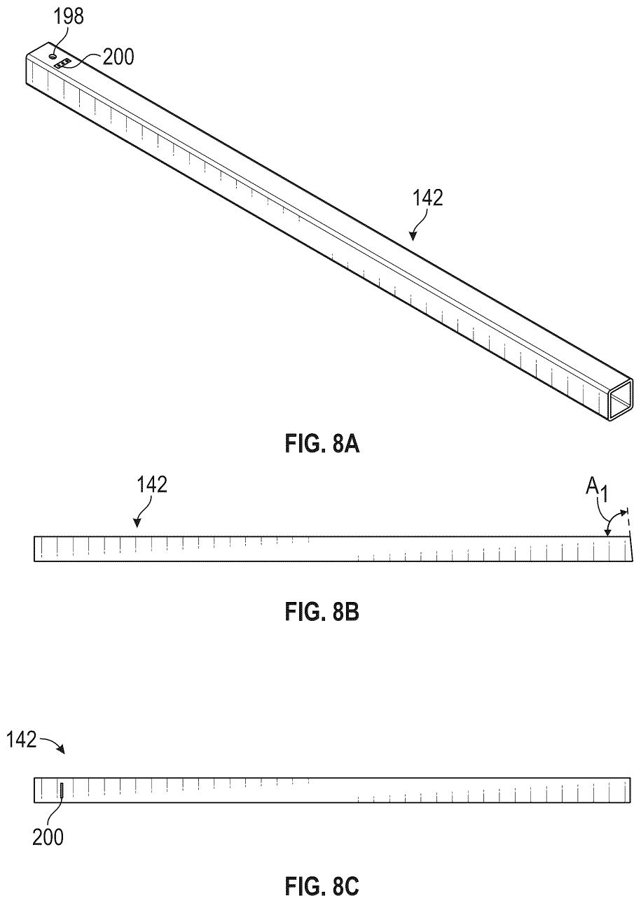

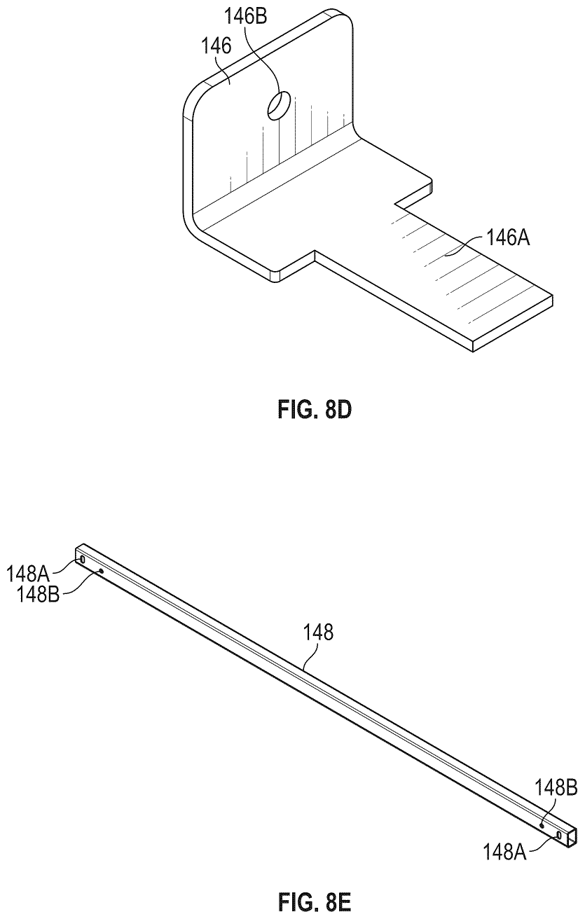

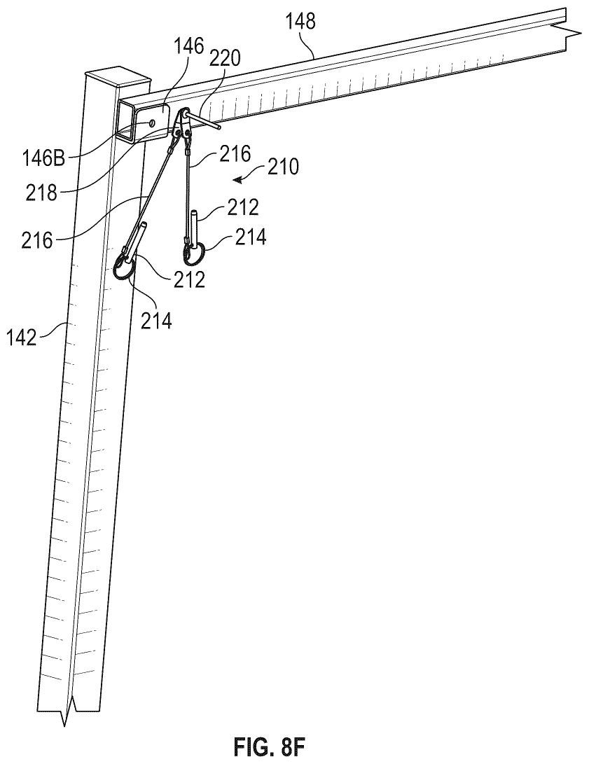

Referring now also to FIGS. 3A, 3B, 4A and 4B, the components of the support assembly 130A, 130B are illustrated. In this example, each support assembly has a cross member 140 that extends and rotates about the respective axes 132A, 132B. The cross member 140, in this example, is rectangular in cross section. The support member 140 has a first side 140A, a second side 140B, a third side 140C and a fourth side 140D. Each cross member 140 has a panel support 142 extending from the side 140B of the cross member 140. The panel support 142 is generally vertically oriented when the support assemblies130 are positioned in the second position. The panel support 142 allows the wall panel assemblies 10 to be positioned thereagainst during transport. Typically, the panel support 142 has a front surface or rear surface positioned against the panel during transport. Although the panel support 142 may be perfectly vertical or at a 90° position relative to the side 140B, the panel support 142, in this example, is positioned about 85° at angle A1 or about 5° from a vertical position. This allows the panel stack to remain in position while loading. The panel supports 142 are positioned off center to allow a large area 144 for loading panels onto the side 140B. Each panel support 142 has a rectangular cross section and is affixed to their respective cross members 140. Although fasteners may be used, welding may be used to fasten the panel supports 142 to the cross members 140. The end of each panel supports 142 may have a receiver 146 coupled thereto. The receiver 146 in this example is L-shaped may be used to receive and support a top member 148 and is described further in reference to FIGS. 8A-8E. The top member 148 may be a separate member that is supported within the tray 102 when the support assemblies 130A, 130B are in the first position A removable pin 150 may be used to secure each side of the top member 148 to their respective panel supports 142 through. The top member 148 may be positioned within the tray 102 as illustrated in FIG. 2B when the cart 100 is in the first position.

The stack supports 142 may have anti-slip areas 152 that extend on the side that the panels rest upon. In the present example, two anti-slip areas 152 are provided. However, the anti-slip areas 152 may extend the entirety of the panel stack supports 142. Other components may also have an anti-slip areas 152 as described below.

The cross members 140 have a stack support 160 coupled thereto. The stack supports 160 are coupled to the first side 140A of the cross member 140. The stack supports 160 are illustrated in greater detail in FIGS. 4A and 4B. In the present example, the stack supports 160 have a pair of flanges 162 that are used to mount the stack support 160 to the side 140A of the cross member 140. Of course, the flanges 162 may be removed if the stack supports 160 are welded or otherwise affixed to the cross member 140. The stack support 160 includes outward members 164 that extend outward from the side 140A of each cross member 140 by a distance H1 The outward member 164 are coupled together by a support cross member 166. That is, the cross member 166 extends between the outward members 164. The outward members 164 and the support cross members 166 are fixed to the cross members 140 and rotate therewith as the cross members rotate about the respective axes 132A and 132B. The height of the outward members 164 together with the support cross member 166 allows one cart 100 to be supported above another cart 100 as illustrated in FIG. 2C so that the wheels 114A-114D are suspended to prevent the movement of one cart relative to the other cart. In one example, the combined height of the outward members 164 and the support cross members 166 allow a tray 102 to be horizontal allowing multiple carts to be stacked rather than just two as illustrated in FIG. 2C. In constructed examples, the total height H1 was between 7.5 inches to 9.5 inches.

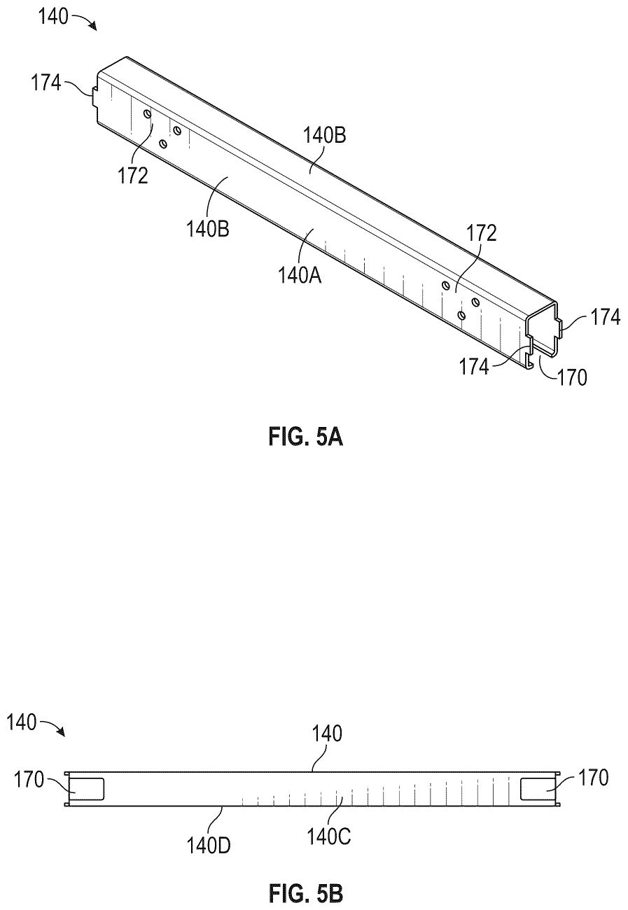

Referring now also to FIGS. 5A and 5B, the cross member 140 is illustrated in further detail. The cross member 140 may have cutouts 170 that extend inward on one side. The cross members 140 may also include holes 172 that are used for coupling the stack supports 160 thereto. In particular, the holes 172 receive fasteners that extend through the flanges 162.

The ends of the cross members 140 may include tabs 174. The tabs 174 are used for coupling to stops as described in greater detail below.

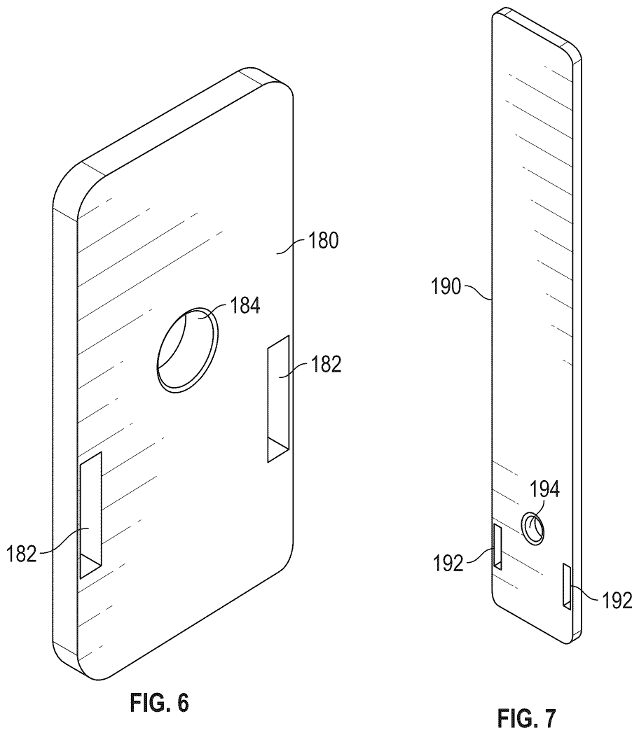

Referring now also to FIG. 6, the support assemblies 130A, 130B may include a panel stop 180 that resists a panel from sliding off the edge cart 100. The panel stops 180 are thin metal pieces that are coupled to a first end of the cross member 140 at slots 182. The slots 182 receive the tabs 174 at one end of the cross member 140. The panel stops 180 also include an opening 184. The opening 184 may be used to receive a fastener 186 as is illustrated best in FIG. 2A. The opening 184 may accommodate a bushing for smooth movement (not shown).

Referring now also to FIG. 7, a second stop 190 is mounted to the cross member 140 on the opposite side from the panel stop 180. The stop 190 is longer than the panel stop 180 and may be used to secure various items used for forming the wall system 12 illustrated in FIG. 1. The stop 190 also includes slots 192 that are also used to receive tabs 174 disposed on one end of the cross member opposite the panel stop 180. In this example, two tabs 174 are received within two slots 192. An opening is also provided. The opening 194 is used to receive the fastener 186, and possibly a bushing (not shown), that allow the cross members 140 to rotate.

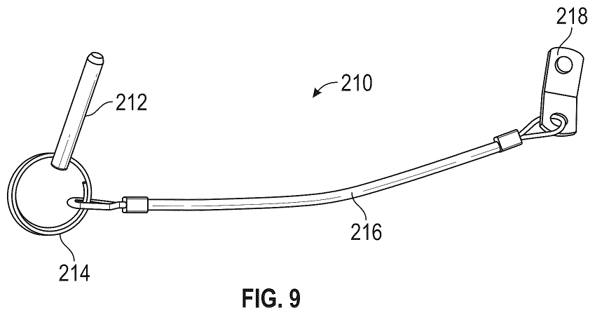

Referring now to FIGS. 8A, 8B and 8C, 8D, 8E, 8F and 9, one example of the panel support 142 is illustrated. The panel support 142, in this example, is disposed at an angle relative to the cross member 140 as best illustrated in FIGS. 2F and 3B. The angle A₁, as described above in FIG. 3A, is 85° to allow the panels to lean against the panel support 142. The receiver 146 illustrated in FIG. 3A may be coupled into to a pair of colinear slots 200. The slots 200 are disposed on opposite sides of the panel support 142. The slots 200 may be used to receive the receiver 146. The receiver 146 may be welded in place in the slots 200 at the extension 146A of the receiver 146. Openings 198 of the panel supports 142 receive one or more quick release pin rings 210 illustrated in FIG. 9. That is, the pin ring 210 may include a pin 212 and a ring 214 that are secured with a tether 216 at a coupler 218 which is coupled to openings 148B of the top member 148 with a fastener 220. The pin 212 may extend through openings 146B of the receiver 146, through the openings 148A of the top member 148 and into the openings 198 of the panel supports 142 so that top member 148 is secured to the panel supports 142 when transporting panels.

To fold the panel supports 142, the pins 212 are removed or disengaged as shown in FIG. 8F, the top member 148 is placed into the tray and the panel supports are folded into the tray 102. This allows the cart 100 to be stacked as the stack supports 160A, 160B are vertical.

Referring back to FIG. 2A, some of the surfaces of the support cross member 166 and the outward members 164 may have anti-slip areas 152 disposed thereon. In FIG. 2A, the side 140A of the cross member 140 also has an anti-slip area 152. The anti-slip area 152 may also be on the top surface of the support member 166 so that when the anti-slip areas 152 contact another cart, slipping is resisted. The support cross members 166 and at least one surface of the cross member 140 on each side of the cart 100 form a planar surface so that panels can rest thereto.

One advantage of the system is that the positioning of the support assemblies 130A, 130B between the various positions are such that the operation may be performed without the use of tools.

Referring now to FIGS. 10A and 10B, a corner bracket 230 is illustrated. The corner bracket 230 is used within the tray and is coupled to the base 104, the walls 108C or 108D and one of the elongated walls 108A and 108B. The bracket 230 has a base 232 with four openings 236 disposed therein. The openings 236 may be used to secure fasteners that are used to secure the wheels 114A to the bottom of the tray 102 through the base 104. A sidewall 238 has four openings 240 disposed therethrough. The openings 240 align with the openings 184 or 194 of the respective stops 180, 190. One of the openings receive a fastener 186 that is used to rotatably couple the cross member 140 thereto. The wall 242 is perpendicular to both the walls 232 and 238. The wall 242 has a height that is the same or lower than the height of the end walls 108C or 108D. The corner bracket 230 reinforces each corner of the cart and provides structural rigidity for the tray 102. Depending on the corner, the corner bracket used may be that shown in FIGS. 10A, 10B or a mirror image thereof.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A cart comprising:
a tray comprising a base having a first edge having a first wall extending therefrom and a second edge opposite the first edge having second wall extending therefrom;
a plurality of wheels coupled to the tray;
a first support assembly comprising a first cross member rotatably coupled between the first wall and the second wall and adjacent to a second edge, said first support assembly comprising a first panel support coupled to the first cross member and a first stack support coupled to the first cross member;
a second support assembly comprising a second cross member rotatably coupled between the first wall and the second wall and adjacent to a fourth edge, said second support assembly comprising a second panel support coupled to the second cross member and a second stack support coupled to the second cross member.

2. The cart of claim 1 further comprising a top member coupled to and extending between the first panel support and the second panel support.

3. The cart of claim 2 further comprising a first removable pin coupling a first end of the top member to the first panel support and a second removable pin coupling a second end of the top member to the second panel support.

4. The cart of claim 2 wherein the first panel support comprises a first receiver coupling to the top member and the second panel support comprises a second receiver comprises a second receiver.

5. The cart of claim 1 wherein the first panel support and the second panel support comprise an anti-slip area.

6. The cart of claim 1 wherein the first panel support and the second panel support are disposed at an angle relative to a vertical position when the first support assembly and the second support assembly are in an upright position.

7. The cart of claim 1 wherein the first cross member comprises a first position having with the first panel support adjacent to the tray and the first stack support vertically disposed and a second position with the first panel support extending outward from the tray and the first stack support extending outward from the tray.

8. The cart of claim 7 wherein the first cross member comprises a panel stop coupled to at a first end thereof, said panel stop extending vertically when the first cross member is in the second position.

9. The cart of claim 8 wherein the first cross member comprises a second stop coupled to a second end thereof, said panel stop extending vertically when the first cross member is in the second position.

10. The cart of claim 7 wherein the first cross member rotates about a first axis and the second cross member rotates about a second axis, said first axis being the same distance to the base as the second axis.

11. The cart of claim 1 wherein the first stack support comprises first outward members coupled to the first cross member and a first support cross member coupled to the first outward members.

12. The cart of claim 11 wherein the first outward members extend from a different side of the first cross member than the panel support.

13. The cart of claim 11 wherein the first outward members and the first support cross member comprise anti-slip areas.

14. The cart of claim 11 a wherein the first outward members extend from a different side of the cross member than the panel support.

15. The cart of claim 11 wherein the second stack support comprises second outward members coupled to the second cross member and a second support cross member coupled to the second outward members.

16. The cart of claim 1 wherein the first wall comprises a slot.

17. The cart of claim 16 wherein the second wall comprises a slot.

18. The cart of claim 1 wherein the tray comprises a third edge having third wall extending therefrom and a fourth edge having a fourth wall extending therefrom.

19. The cart of claim 1 wherein the tray comprises a plurality of corner brackets coupled to the base and to the plurality of wheels.
